(19) United States
(12) Patent Application Publication
(10) Pub. No.: US 2011/0185582 A1
(43) Pub. Date: Aug. 4, 2011

(54) POWER TOOL, ESPECIALLY HAND-HELD POWER TOOL

(75) Inventors: Thilo Koeder, Gerlingen (DE); Joachim Platzer, Remseck-Hochberg (DE); Ulli Hoffmann, Niefern-Oeschelbronn (DE)

(73) Assignee: Robert Bosch GMBH, Stuttgart (DE)

(21) Appl. No.: 12/992,221

(22) PCT Filed: Mar. 16, 2009
(86) PCT No.: PCT/EP2009/053034

§ 371 Date: Feb. 23, 2011

(30) Foreign Application Priority Data
May 14, 2008 (DE) 102008001756.6

(51) Int. Cl. B23D 49/16; B23D 61/12; B23D 51/00

(52) U.S. Cl. 30/392; 83/835; 30/290

(57) ABSTRACT

The invention relates to a power tool (1), especially in the form of a jigsaw (2), which comprises a saw blade (8). The back (39) of said saw blade is supported by a supporting member, which, even when in the shape of a supporting roller (36, 37), allows a controlled support of the saw blade (8) both in the pendulum stroke mode and in the scrolling mode.

The invention relates to a power tool according to the generic term of claim 1.

### STATE OF THE ART

Power tools of the previously mentioned type are known from EP 1 598 134 B1 as jigsaws that are driven by an electro motor and can be operated at a saw blade that is driven in a manner allowing stroke movement as pendulum stroke saws with a saw blade that is additionally driven around the longitudinal axis of the saw blade in a manner allowing pivoting movement as well as a so-called scrolling jigsaw, at which the saw blade that is driven in a manner allowing stroke movement can additionally be rotated around its longitudinal axis.

At a saw blade holder that is provided below its connection between the saw blade and the lifting rod the saw blade is supported in all operating modes by a supporting member, which, regarding the rotation axis of the lifting rod and the saw blade that is fixed in position to it, is arranged rotationally with the lifting rod and which impinges the saw blade in the direction of the extension of the saw blade plane. A supporting roller with a notched, gutter shaped slot that is at its circumference is provided as supporting member, into which the saw blade meshes with its back area.

Due to the fact that the supporting member that is construed as a roller is rotating in the scrolling mode along with the lifting rod and with the saw blade, therefore the same rotational positions of the supporting member and of the saw blade are given in all operating modes with regard to the rotation axis of the lifting rod and saw blade, the supporting conditions between the saw blade and the supporting member are mostly the same despite different exposure circumstances in the different operating modes, even if due to the different exposure circumstances at a different wear in particular of the supporting member. Corresponding wear marks can ultimately cause an interference of the guiding quality and the working result.

### DISCLOSURE OF THE INVENTION

With the invention different exposure circumstances between the supporting member and the saw blade in the different operating modes can be taken into account, but in particular also a configuration can be achieved, which is not bound to the arrangement of the supporting member that is rotating along with the saw blade, but which is also to be used in connection with configurations of the power tool, at which the saw blade pivots towards the not rotating supporting member in the scrolling mode.

According to the invention this can be simply achieved with the characteristics of claim 1, whereby the configurations of the supporting member that are provided in that context can advantageously also be used at other supporting circumstances between the supporting member and the saw blade.

The invention assumes in claim 1 that the supporting member provides at least two operating positions, which can be used optionally, so that different requirements can be taken into account by different configurations of the supporting areas of the supporting member that are each put into the supporting position towards the saw blade.

A particularly simple solution for such a configuration is to assign the supporting areas to different sides of the supporting member, in particular sides that are facing each other, so that by moving the supporting member, in particular by rotating or pivoting the supporting member optionally in adjustment to the corresponding operating mode, one or the other supporting area can be used.

A simple adjustment with the possibility to still save the corresponding position of the supporting member with simple means, consists in the fact, that the supporting member can be adjusted into a corresponding working position around a pivot axis with a corresponding supporting area that lies between its supporting areas that are opposite of each other, whereby it is useful if the pivot axis for the support member runs vertically to a plane that contains the longitudinal axis of the saw blade.

The corresponding support areas can be created by supporting elements, which are fixed in position toward the supporting member, or also by supporting elements, which are connected movably with the supporting member. In this regard rollers or also cylindrical bodies, which are adjusted in their circumferential contour to the corresponding purpose and which preferably provide concavely formed circumferential contours, qualify, if, for example in the scrolling mode, a support of the rotatable saw blade towards the supporting element that is fixed in position is required. In contrast for the pendulum stroke mode at a supporting element that is moved in the pendulum plane with the saw blade a contour of the same is for example useful, which can cause a certain transversal support for the saw blade in the back area, also for example a notch shaped guiding contour.

Despite a configuration in one or the other form that has been previously mentioned it is useful to determine the pivotable supporting member in its corresponding pivoting positions by the simplest interlocking means, thus for example by detent holders or such alike.

One configuration with a guiding contour, at which the convexly vaulted contour area creates a support contour, which is rounded in the traverse section and whose rounding radius corresponds at least in essence with the distance of the rotation axis of the saw blade from the saw blade back, constitutes a particularly favorable solution. This applies also to supporting elements configured as supporting rollers and also to a supporting member that does not pivot along with the saw blade in the scrolling mode, because basically only a pivoting area of the saw blade of approximately +/−30° has to be covered ordinarily, so that it is possible to carry out the support of the saw blade back by the corresponding equivalent support member or supporting element, independent of the operating mode, within the scope of the invention.

This applies in particular if by virtue of a further independent configuration according to the invention the saw blade provides a rounded back area that runs into its edges, so that only a linear support results between the saw blade and the corresponding support member, in particular also of a supporting roller that is construed according to the previous explanation, by which a getting caught up of the saw blade at pivoting movements towards the support member is practically ruled out, so that also corresponding shrink and chatter marks are avoided.

Further advantages and useful embodiments are to be taken from the claims, the description of the figures and the drawings. It is shown in:

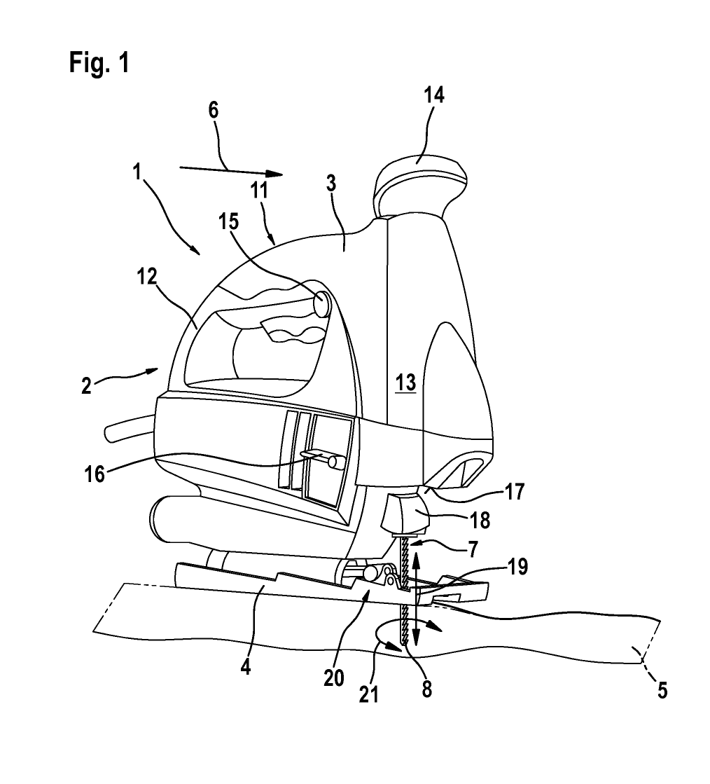

FIG. 1 a schematic illustration of an electrically driven jigsaw that is construed as a hand-held power tool, which has to be operated in different operating modes,

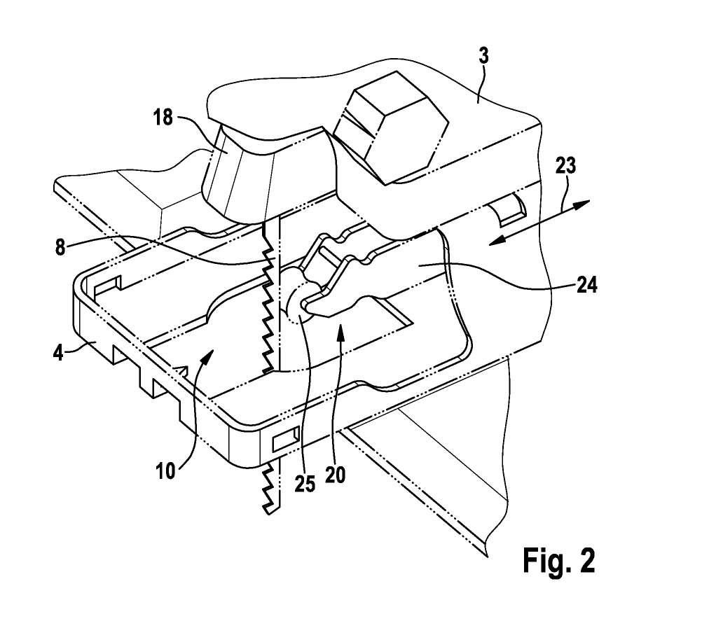

FIG. 2 the working area of a jigsaw similar to the one in FIG. 1 with a saw blade and a supporting member that is assigned to it on the back side, again in perspective and simplified,

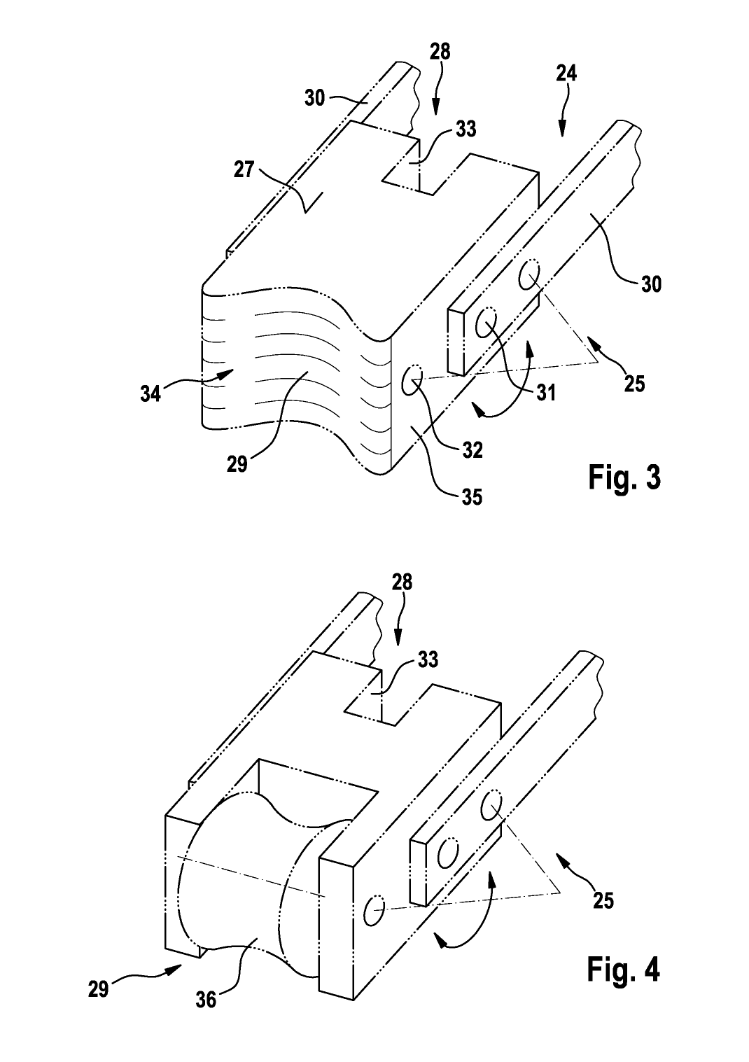

FIGS. 3 and 4 configurations of a supporting member, which provides separate supporting areas, which can be adjusted by adjusting the supporting member into its supporting position towards the saw blade, again schematically and in perspective,

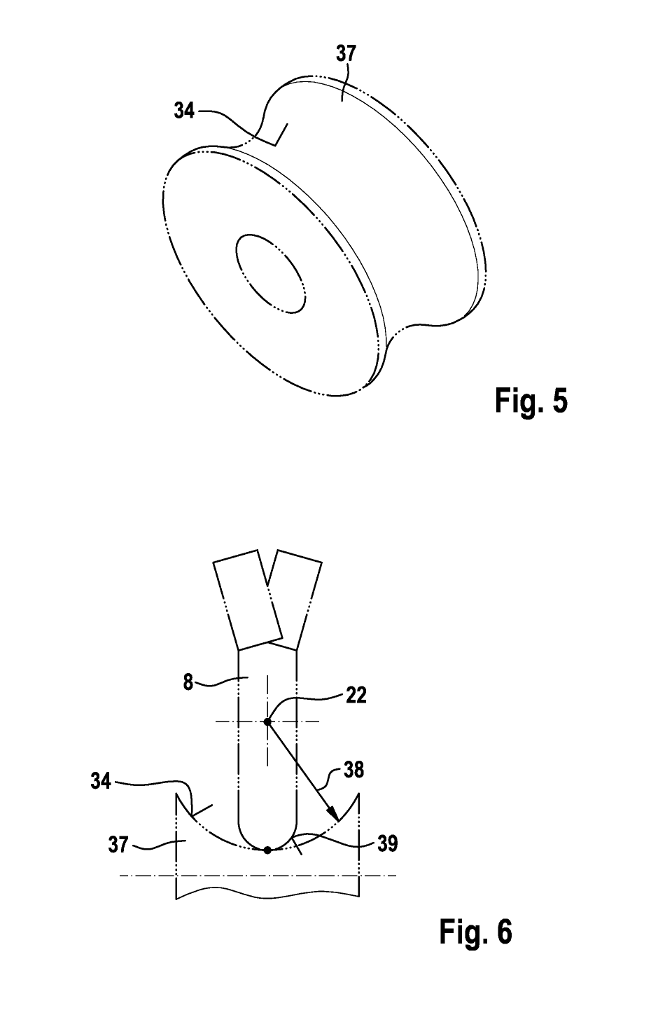

FIG. 5 a perspective view of a supporting roller, which as a supporting element, corresponding with FIG. 4, can be a component of a supporting member, or over which the support of a saw blade can also take place in different operating modes as independent supporting member, and

FIG. 6 a schematic illustration of a configuration of a saw blade according to the invention with a rounded saw blade back assigned to a supporting member with a concavely vaulted supporting contour.

FIG. 1 illustrates a hand-held machine in the form of a jigsaw 2 as an example of a power tool 1, which provides a housing 3 and which is supported over a foot plate 4 on a work piece 5.

In the front area of the jigsaw 2 in working direction it provides a saw blade 8 as working tool 7. It encroaches during the working process upon the work piece 5, on which the jigsaw 2 is supported movably over a foot plate 4.

The jigsaw 2 provides a field of view 10 for the user, which expands at least over the working area 9 that is determined by the saw blade 8. At the housing 3 of the jigsaw 2 in vertical direction opposing the foot plate 4 that is supported around a pivot axis that is running in working direction 6, a handle 11 is provided, whose handle bow 12 runs towards a guiding knob 14. Engaging under the handle bow 12 a switch assembly 15 is provided, by which the jigsaw 2 can be switched on and off. Different operating modes of the jigsaw 2 can be adjusted over the switch assembly 16 which is provided on the longitudinal side of the housing 3. The front wall area 13 of the housing 3 is offset stepwise contrary to the working direction while running towards the foot plate 4. The step 17 covers the power tool holder 18 for the working tool 7 that is created and driven by the saw blade 8.

The saw blade 8 of the overall electrically operated power tool 1 provides a basic working position, in which it is only driven in a manner allowing stroke movement, as it is shown by the arrow 19. The back of the saw blade 8 is assigned to a support 20. This support 20 is driven by a not further shown drive in the direction of the plane of the saw blade 8, thus in the direction of sawing again in a manner allowing stroke movement (arrow 23). This results in a further working mode, namely the so-called pendulum stroke operation, at which the saw blade 8 can be pivoted around a not further shown pivot axis that runs transversely to its blade plane, overlapped towards the stroke movement that runs in longitudinal direction of the saw blade 8. In a third operating mode, illustrated by the arrow 21, the saw blade 8 can additionally be rotated towards the stroke movement in the direction of its longitudinal axis around a rotation axis 22 that runs towards its direction (FIG. 6). Thereby the saw blade 8 can be adjusted in working directions that have an angle towards its straight working direction according to arrow 6, so that the jigsaw can be used as so-called “scrolling jigsaw” and which can also be operated as semi-autonomous jigsaw at a correspondingly controllable adjustment. Thereby the user that is holding the jigsaw 2 basically takes only over the feed that is roughly directed towards the working direction 6, while an exact positioning oriented according to a path guideline by adjusting the saw blade 2 to a corresponding rotational position that is oriented according to the path guideline.

In the configuration that is illustrated in FIG. 2 the support 20 provides a supporting frame 24 outbound towards the saw blade 8 that can be adjusted in the direction of the arrow 23 for a support member 25, which is construed in FIG. 2 as supporting roller 26.

Configurations of such a support member 25 according to the invention are shown in FIGS. 3 and 4, whereby the support member 25 provides support areas 28, 29, which are assigned according to these configurations to a supporting body 27 and which are assigned to ends that are facing each other at the box-shaped supporting body 27.

In FIG. 3 the box-shaped supporting body 27 is arranged to allow pivoting at the supporting frame 24 that is symbolized by two support arms 30, namely around a pivot axis 31 that lies between the support areas 28 and 29. In pivot positions that are offset by 180° the supporting body 27 can be interlocked or engaged towards the support arms 30, as it is illustrated by indicated engagement points 32. Insofar the construction is the same in FIGS. 3 and 4.

In the configuration according to FIG. 3 the support area 28 is construed as a guide channel 33, which is adjusted in its dimensions to the transverse section of the saw blade 8, so that the saw blade 8 engages with its back in the u-shaped guide channel 33 in the pendulum stroke operation at the position of the supporting body 27 that is rotated by 180° in the illustrations according to FIGS. 3 and 4 and thereby a transverse guiding is achieved for the saw blade 8 by the shanks of the u-shaped channel 33 in the pendulum stroke operation, but also in the regular working operation.

Analogously to the support area 28, in the opposite support area 29 the supporting body 27 creates itself a concavely vaulted guide channel 34 for the saw blade 8 that is pivoting relatively towards fixed supporting body 27 in scrolling mode. Because the pivoting area of the saw blade 8 covers an angle area of approximately +/−30° in the scrolling mode, a sufficient support for the saw blade 8 already results at a relatively flat convex vaulting of the guiding channel 34, accompanied by a sufficient lateral guiding. An additional protection against lateral deviation of the saw blade 8 from the guide channel 34 can further be achieved thereby, in that the guide channel 34 runs rounded into the side areas 35 of the supporting body 27, namely at fringes that are steeper in the direction towards the rounded transition than the convexly vaulted area of the guide channel 34. But also for that support area 29 a configuration may be useful with a guide channel, approximately corresponding with the configuration for the guiding area 28.

Instead of a guide channel 34 according to FIG. 3 that is in a fixed position towards the supporting body 27, the support area 29 in the configuration according to FIG. 4 is created by a supporting element in the form of a supporting roller 36, which is mounted in a rotatable manner towards the supporting body 27 and which preferably corresponds with the supporting roller 37 according to FIG. 5 at a concavely vaulted circumferential area. The supporting roller 37 is just like the supporting roller 36 concavely vaulted, whereby the rounding radius 38, as it is illustrated in FIG. 6, at least approximately, but preferably exactly corresponds with the distance of the saw blade back 39 from the rotation axis 22 of the saw blade 8. Such an adjustment between the configuration of the guide channel 34 and the position of the guide channel 34 towards the rotation axis 22 of the saw blade 8 ensures that the saw blade 8 is supported in all rotational positions perpendicular, or at least almost perpendicular against the guide channel 34 of the supporting roller 37.

Expediently the guide channels 34 are hardened as standing guide channels as well as as guide channels that are created by rollers 36, 37. But it also lies within the scope of the invention to use rollers that are arranged in a non-rotatable manner for fixed guide channels. Furthermore the guide channels that are created by rollers can also be construed in the shape of a channel in order to achieve a transverse guide through the lateral encroachment to the saw blade 8, and thereby a lateral support of the saw blade.

FIG. 6 illustrates furthermore a configuration of the saw blade 8 according to the invention with a rounded saw blade back 39, so that only an almost linear contact results between the saw blade 8 and the guide channel 34 of the corresponding supporting roller, thus for example of the supporting roller 37, which practically rules out a getting caught up getting caught up and jamming between the saw blade 8 and the supporting roller 37 when pivoting the saw blade 8 towards the supporting roller 37. Additionally the wear is thereby reduced, whereby such a configuration of the saw blade 8 is also useful if the support does not take place against a supporting roller, for example against the supporting roller 37, but against the guide channel 34 of the fixed supporting body 27, if corresponding assessment circumstances are given.

1. Power tool, especially hand-held power tool, in the form of a jigsaw, which has to be operated in different operating modes and whose saw blade can be pivoted in the pendulum stroke mode around a rotation axis that is running transversely to its longitudinal extension and which is rotatable around its rotation axis in scrolling mode and which is supported in both operating modes below the saw blade holder on the back side against a supporting member wherein the supporting member provides separate supporting areas for supporting the saw blade in the pendulum stroke mode and in the scrolling mode, which have to be used in each mode alternately by adjusting the supporting member.

2. The power tool according to claim 1 wherein the supporting areas are provided at different sides of the supporting member, that are in particular facing each other.

3. The power tool according to claim 1 wherein the supporting areas can be adjusted into its corresponding working position by pivoting the supporting member in particular around an axis that lies between the supporting areas.

4. The power tool according to claim 3 wherein the pivot axis for the supporting member runs vertically to a plane that contains the rotation axis of the saw blade.

5. The power tool according to claim 1, wherein the supporting areas provide different contours for the pendulum stroke mode and for the scrolling mode.

6. The power tool according to claim 1, wherein at least one of the supporting areas is provided at a supporting element that is carried by the supporting member and that is fixed in position or movable to the supporting member.

7. The power tool according to claim 1, wherein a supporting roller is provided as movable supporting element.

8. The power tool according to claim 1, wherein the supporting area that is provided for the pendulum stroke mode creates a guide channel for the saw blade.

9. The power tool according to claim 1, wherein the supporting area that is provided for the scrolling mode provides a concavely vaulted supporting contour.

10. The power tool according to claim 9, wherein the supporting area that is provided for the scrolling mode is created by a supporting roller.

11. The power tool according to claim 9 wherein the concavely vaulted contour of the supporting area merges into rounded lateral edges.

12. The power tool according to claim 1, wherein the vaulted contour of a supporting area provides a rounding radius, which corresponds at

13. Power tool according to one of the claims 1 to 12 is thereby characterized, in that the supporting member (25) can be interlocked in its corresponding pivoting position towards its supporting frame (30).

14. Saw blade for power tools, in particular for power tools with a support of a saw blade on the back, in particular according to one or several of the previous claims, is thereby characterized, in that the saw blade (8) provides a rounded back area (39) that runs into its edges.

15. Supporting roller for saw blades (8) of power tools, in particular for power tools (1) in the form of jigsaws (2), at which the saw blade (8) is supported by the supporting roller (36, 37) on the back, in particular according to one or several of the previous claims. I thereby characterized, in that the supporting roller (36. 37) provides a contour that is concavcly vaulted at its circumference and whose rounding radius corresponds with the distance between the saw blade back (39) and the rotation axis (22) of the saw blade (8) that has to be supported.

16. Supporting roller according to claim 15 is thereby characterized, in that the shoulders of the supporting roller (36, 37) are rounded.
